(19) United States
(12) Patent Application Publication
(10) Pub. No.: US 2018/0278453 A1
(43) Pub. Date: Sep. 27, 2018

(54) SELECTED MAPPING (SLM) COMMUNICATION METHOD AND APPARATUS WITHOUT SIDE INFORMATION (SI) USING CROSS-CORRELATION

(71) Applicant: Electronics and Telecommunications Research Institute, Daejeon (KR)

(72) Inventors: Jong Keun LEE, Suwon-si (KR); Dae Ig CHANG, Daejeon (KR); Deock Gil OH, Daejeon (KR)

(73) Assignee: Electronics and Telecommunications Research Institute, Daejeon (KR)

(21) Appl. No.: 15/711,332

(22) Filed: Sep. 21, 2017

(30) Foreign Application Priority Data
Mar. 27, 2017 (KR) 10-2017-0038388

(51) Int. Cl. H04L 27/26; H04L 27/34; H04L 25/02

(52) U.S. Cl. CPC H04L 27/2621; H04L 27/3411; H04L 27/2605; H04L 27/2626; H04L 25/0204; H04L 27/2615

(57) ABSTRACT

Disclosed is a communication method and apparatus without side information (SI) using a cross-correlation. The communication method may include obtaining a reception pilot signal from a reception signal, and detecting a phase sequence used for a transmission signal based on the reception pilot signal.

### CROSS-REFERENCE TO RELATED APPLICATION(S)

This application claims the priority benefit of Korean Patent Application No. 10-2017-0038388 filed on Mar. 27, 2017, in the Korean Intellectual Property Office, the disclosure of which is incorporated herein by reference for all purposes.

### BACKGROUND

### 1. Field

One or more example embodiments relate to a method of detecting a used phase sequence without transmitting side information (SI) in an orthogonal frequency division multiplexing (OFDM)-selected mapping (SLM) apparatus for decreasing a peak-to-average power ratio (PAPR) of a wireless communication system and an apparatus performing thereof.

### 2. Description of Related Art

An orthogonal frequency division multiplexing (OFDM) system has been widely used because the OFDM system is robust against a frequency selective channel in various wireless communication systems, for example, an Institute of Electrical and Electronics Engineers (IEEE) 802.11, a digital video broadcasting-terrestrial (DVB-T), and a long-term evolution (LTE). The OFDM system may have a problem that a peak-to-average power ratio (PAPR) increases because multiple subcarriers are transmitted in the OFDM system. In response to the PAPR increasing, the number of distorted signal is increased because of nonlinearity of a power amplifier. Thus, the signal may be unable to be detected from a reception end. Therefore, research on technologies for decreasing a PAPR has been continuously conducted.

### SUMMARY

An aspect provides a technology for increasing a transmission efficiency by detecting a phase sequence used for a receiving apparatus without transmitting side information (SI) on the used phase sequence to prevent the transmission efficiency from being reduced.

According to an aspect, there is provided a communication method including obtaining a reception pilot signal from a reception signal, and detecting a phase sequence used for a transmission pilot signal based on the reception pilot signal in the OFDM-SLM (Orthogonal Frequency Division Multiplexing-SeLected Mapping) symbol.

The detecting may include detecting the used phase sequence at a transmitter by performing a cross-correlation based on the reception pilot signal and a transmission pilot signal.

The detecting of the used phase sequence by performing the cross-correlation may include modulating the transmission pilot signal by multiplying the transmission pilot signal by a plurality of phase sequences, generating cross-correlation values by performing a cross-correlation operation on the modulated transmission pilot signal and the reception pilot signal, and squaring and adding the cross-correlation values, and detecting the used phase sequence by selecting a maximum value from values obtained by squaring and adding the cross-correlation values.

The detecting may include detecting the used phase sequence based on the following equation:

$${u}^{⋒} = {max}_{u ∈ \{ 1 , 2 , … , U \}} ( {\sum }_{i = 1 - {N}_{p}}^{{N}_{p} - 1} \vert {R}_{{X}_{p}^{u} {Y}_{p}} ( i ) {\vert}^{2} )$$

wherein û denotes an index of a phase sequence to be detected, R_{X}_{ₚ}_{^{u}}_{Y}_{ₚ}(i) denotes a cross-correlation value of a modulated transmission pilot signal Xₚ^{u} and a reception pilot signal Yₚ, and Nₚ denotes a number of transmission pilot signals or a number of reception signals in an OFDM symbol.

The generating may include determining the cross-correlation values based the following equation:

$${R}_{{X}_{p}^{u} {Y}_{p}} ( i ) = {\sum }_{m = 1}^{{N}_{P}} {{X}_{p}^{u} ( m + i )}^{*} {Y}_{p} ( m ) , 1 \leq m + i \leq {N}_{p}$$

wherein Xₚ^{u} denotes the modulated transmission pilot signal, Yₚ denotes the reception pilot signal, and Nₚ denotes the number of the transmission pilot signals or the number of the reception signals in the OFDM symbol.

The communication method may further include detecting data based on the detected phase sequence.

The detecting of the data may include detecting the data based on a maximum likelihood (ML) method using the detected phase sequence.

According to another aspect, there is provided a communication apparatus including a receiver configured to obtain a reception pilot signal from a reception signal, and a calculator configured to detect a phase sequence used for a transmission pilot signal based on the reception pilot signal in the OFDM-SLM (Orthogonal Frequency Division Multiplexing-SeLected Mapping) symbol.

The calculator may be configured to detect the used phase sequence at a transmitter by performing a cross-correlation based on the reception pilot signal and a transmission pilot signal.

The calculator may include a multiplier configured to modulate the transmission pilot signal by multiplying the transmission pilot signal by a plurality of phase sequences, a cross-correlation operator configured to generate cross-correlation values by performing a cross-correlation operation on the modulated transmission pilot signal and the reception pilot signal, and squaring and adding the cross-correlation values, and a selector configured to detect the used phase sequence by selecting a maximum value from values obtained by squaring and adding the cross-correlation values.

The selector may be configured to detect the used phase sequence based on the following equation:

$${u}^{⋒} = {max}_{u ∈ \{ 1 , 2 , … , U \}} ( {\sum }_{i = 1 - {N}_{p}}^{{N}_{p} - 1} \vert {R}_{{X}_{p}^{u} {Y}_{p}} ( i ) {\vert}^{2} )$$

wherein û denotes an index of a phase sequence to be detected, R_{X}_{ₚ}_{^{u}}_{Y}_{ₚ}(i) denotes a cross-correlation value of a modulated transmission pilot signal Xₚ^{u} and a reception pilot signal Yₚ, and Nₚ denotes a number of transmission pilot signals or a number of reception pilot signals in an OFDM symbol.

The cross-correlation operator may be configured to determine the cross-correlation values based on the following equation:

$${R}_{{X}_{p}^{u} {Y}_{p}} ( i ) = {\sum }_{m = 1}^{{N}_{P}} {{X}_{p}^{u} ( m + i )}^{*} {Y}_{p} ( m ) , 1 \leq m + i \leq {N}_{p}$$

wherein Xₚ^{u} denotes the modulated transmission pilot signal, Yₚ denotes the reception pilot signal, and Nₚ denotes the number of the transmission pilot signals or the number of the reception pilot signals in the OFDM symbol.

The communication apparatus may further include a detector configured to detect data based on the detected phase sequence.

The detector may be configured to detect the data based on a maximum likelihood (ML) method using the detected phase sequence.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a selected mapping (SLM) operation of an orthogonal frequency division multiplexing (OFDM) system according to an example embodiment;

FIG. 2 is a block diagram illustrating a communication apparatus according to an example embodiment;

FIG. 3 is a block diagram illustrating a calculator according to an example embodiment;

FIG. 4 illustrates an example of an operation of the communication apparatus of FIG. 2;

FIG. 5 is a graph illustrating an example of a phase sequence detecting performance of the communication apparatus of FIG. 2; and

FIG. 6 is a graph illustrating another example of a phase sequence detecting performance of the communication apparatus of FIG. 2.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions may not be described in detail because they would obscure the description with unnecessary detail.

The terminology used herein is for the purpose of describing the example embodiments only and is not intended to be limiting of the disclosure. As used herein, the singular forms “a,” “an,” and “the” are intended to include the plural forms as well, unless the context clearly indicates otherwise. It will be further understood that the terms “include/comprise” and/or “have,” when used in this disclosure, specify the presence of stated features, integers, steps, operations, elements, components, or combinations thereof, but do not preclude the presence or addition of one or more other features, integers, steps, operations, elements, components, and/or groups thereof. In addition, the terms such as “unit,” “-er (-or),” and “module” described in the specification refer to an element for performing at least one function or operation, and may be implemented in hardware, software, or the combination of hardware and software.

Terms such as first, second, A, B, (a), (b), and the like may be used herein to describe components. Each of these terminologies is not used to define an essence, order or sequence of a corresponding component but used to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments are described in detail with reference to the accompanying drawings. Like reference numerals in the drawings denote like elements, and a known function or configuration will be omitted herein.

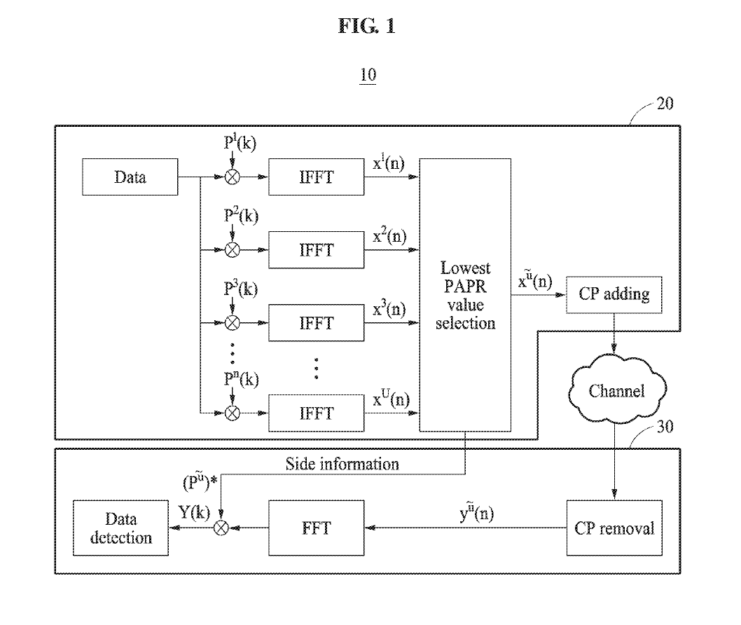

FIG. 1 is a diagram illustrating a selected mapping (SLM) operation of an orthogonal frequency division multiplexing (OFDM) system according to an example embodiment.

Referring to FIG. 1, an OFDM system 10 includes a transmitting apparatus 20 and a receiving apparatus 30.

The transmitting apparatus 20 modulates transmission data to be transmitted using phase sequences. The transmitting apparatus 20 converts modulated signals into time domain signals (or time scale signals) by performing an inverse fast Fourier transform (IFFT) on the modulated signals. The transmitting apparatus 20 selects a signal having a lowest a peak-to-average power ratio (PAPR) by performing the SLM method on the converted time domain signals. The transmitting apparatus 20 adds a cyclic prefix (CP) to the selected signal and transmits the signal to the receiving apparatus 30 through a channel.

The transmitting apparatus 20 transmits, to the receiving apparatus 30, side information (SI) on a phase sequence used for the signal having the lowest PAPR.

The receiving apparatus 30 removes the CP from the received signal and then detects data based on the SI by performing a fast Fourier transform (FFT).

Hereinafter, descriptions about a method of calculating a PAPR and an SLM method of the OFDM system 10 are provided.

In the general OFDM system including N subcarriers, X(k) is a signal that a pilot is inserted into an input data symbol in a frequency domain. Here, x(n) denotes a time domain signal, that is, a frequency domain signal transformed to a time domain signal (or frequency domain signal transformed to time scale signal through the IFFT. The time domain signal x(n) is expressed as shown in Equation 1.

$$x ( n ) = \frac{1}{\sqrt{N}} {\sum }_{k = 0}^{N - 1} X ( k ) {e}^{j \frac{2 π kn}{N}} , 0 \leq n \leq N - 1 \qquad [ Equation 1 ]$$

In Equation 1, N denotes a number of subcarriers. When max[|x(n)|²] denotes a power of a subcarrier having a maximum power value among subcarriers of the signal x(n) corresponding to the time domain signal transformed after performing the IFFT, and B[|x(n)|²] denotes an average value of power of the subcarriers, a PAPR is calculated as shown in Equation 2.

$$PAPR = \frac{{max}_{n ∈ \{ 1 , 2 , … , N \}} [ \vert x ( n ) {\vert}^{2} ]}{E [ \vert x ( n ) {\vert}^{2} ]} \qquad [ Equation 2 ]$$

An SLM method for decreasing the PAPR is as follows.

The SLM method generates U phase sequences of which a length corresponds to N. L denotes an interval between pilot signals, m denotes a quotient k divided by L, and l denotes a remainder after dividing k by L. Because a pilot signal is inserted into a transmission signal generated in a frequency domain for a channel estimation, the transmission signal is classified into a data signal and a pilot signal as shown in Equation 3.

$$X ( k ) = X ( mL + l ) = \{ \begin{matrix}{X}_{p} ( m ) & , l = 0 \\ {X}_{d} ( mL + l ) & , l = 1 , 2 , … , L - 1\end{matrix} , 1 \leq m \leq {N}_{p} \qquad [ Equation 3 ]$$

In Equation 3, Xₚ denotes a pilot signal, Nₚ denotes a number of pilot signals, and X_{d} denotes a data signal. To transmit the signal to the time domain, a time domain signal having N subcarriers is generated in response to the IFFT being performed on a signal by which a phase sequence is multiplied as shown in Equation 4.

$${x}^{u} ( n ) = \frac{1}{\sqrt{N}} {\sum }_{k = 0}^{N - 1} X ( k ) {P}^{u} ( k ) {e}^{j \frac{2 π kn}{N}} , 0 \leq n \leq N - 1 \qquad [ Equation 4 ]$$

In Equation 4, P^{u}(k) denotes a phase value obtained by multiplying a k-th subcarrier and a u-th phase sequence. The U signals in the time domain are generated by performing the IFFT on the signal by which each phase sequence is multiplied. The PAPR is calculated with respect to each of the U time domain signals and then a signal having a lowest PAPR is determined to be a signal to be transmitted. The signal having the lowest PAPR is expressed as shown in Equation 5.

$${x}^{\hat{u}} ( n ) = {min}_{u ∈ \{ 1 , 2 , … , U \}} [ \frac{{max}_{n ∈ \{ 1 , 2 , … , N \}} [ \vert {x}^{u} ( n ) {\vert}^{2} ]}{E [ \vert {x}^{u} ( n ) {\vert}^{2} ]} ] \qquad [ Equation 5 ]$$

In Equation 5, because information on the phase sequence used for the transmission signal transmitted by the transmitting apparatus 20 is unknown, the transmitting apparatus 20 may provide phase sequence information for the receiving apparatus 30. Thus, the transmitting apparatus 20 allows side information (SI), that is, the information on the phase sequence used for the transmission signal, to be robust against an error by performing channel coding, and then transmits the SI to the receiving apparatus 30. The receiving apparatus 30 detects data based on the phase sequence obtained from the SI.

The OFDM system 10 decreases the PAPR without a data loss based on the above-described SLM method, but a bit number corresponding to log₂ U is additionally needed because of transmission of the SI. Thus, the transmission efficiency may be reduced. In addition, when the receiving apparatus 30 falsely receives the SI, a relatively strong channel coding may be used because the receiving apparatus 30 may falsely verify all transmission signals. Thus, the transmission efficiency may be more reduced.

Hereinafter, descriptions about a method of detecting a phase sequence used for a transmission signal without transmitting and receiving SI to prevent a transmission efficiency from being reduced in the OFDM system and a communication apparatus 50 performing thereof are provided.

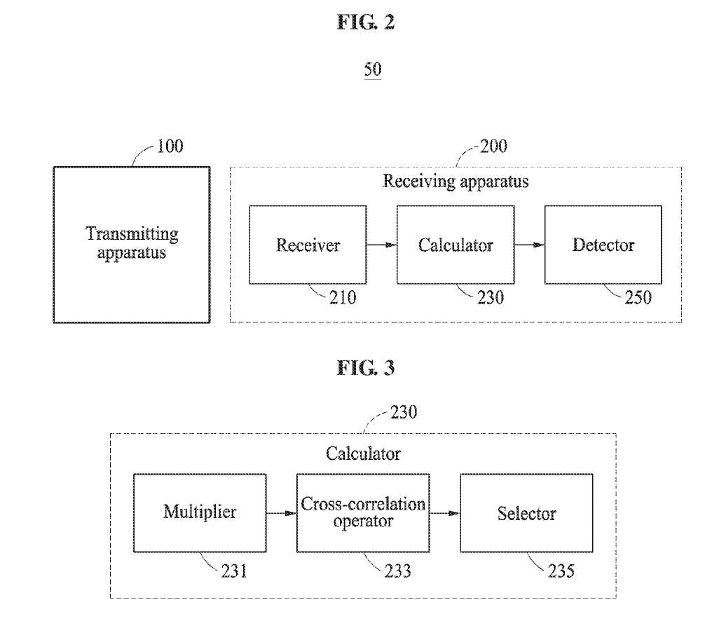

FIG. 2 is a block diagram illustrating the communication apparatus 50 according to an example embodiment.

Referring to FIG. 2, the communication apparatus 50 includes a transmitting apparatus 100 and a receiving apparatus 200. The communication apparatus 50 may be implemented by an orthogonal frequency division multiplexing (01-DM) communication system or an OFDM-selected mapping (SLM) communication system.

The transmitting apparatus 100 modulates transmission data using phase sequences. The transmitting apparatus 100 converts modulated signals into time domain signals by performing an inverse fast Fourier transform (IFFT) on the modulated signals. The transmitting apparatus 100 selects a signal having a lowest a peak-to-average power ratio (PAPR) by performing an SLM method on the converted time domain signals. The transmitting apparatus 100 adds a cyclic prefix (CP) to the selected signal and transmits the signal to the receiving apparatus 200 through a channel.

The transmitting apparatus 100 may perform an operation substantially identical to that of the transmitting apparatus 20 of FIG. 1.

The receiving apparatus 200 may receive a signal, for example, a reception signal, transmitted from the transmitting apparatus 200 and detect a phase sequence used for the transmission signal by the transmitting apparatus 100 based on the reception signal. In addition, the receiving apparatus 200 may detect data using the detected phase sequence.

For example, the reception signal is a signal obtained in response to the transmission signal transmitted from the transmitting apparatus 100 passing through a channel. Also, the reception signal may include an additive white Gaussian noise (AWGN). The reception signal is expressed as shown in Equation 6.

Y(k)=H(k)P^{ũ}(k)X(k)+W(k) [Equation 6]

In Equation 6, P^{ũ}(k) denotes a phase sequence used for a transmission signal in the transmitting apparatus 100, X(k) denotes the transmission signal, H(k) denotes a response of a channel, and W(k) denotes an AWGN.

The receiving apparatus 200 includes a receiver 210, a calculator 230, and a detector 250.

The receiver 210 removes the CP added in the transmitting apparatus 100. The receiver 210 receives the reception signal and obtains (or detects) a reception pilot signal and a data signal from the reception signal. The receiver 210 may output the reception pilot signal and the data signal to the calculator 230. For example, the reception pilot signal and the data signal may be a frequency domain signal and/or a time domain signal.

In addition, the receiver 210 may store information on a transmission pilot signal and a phase sequence used in the transmitting apparatus 100, and output the transmission pilot signal and the phase sequence to the calculator 230.

A number of transmission/reception pilot signals may correspond to a number of subcarriers for transmitting pilot signals existing in a symbol in an OFDM system. The transmission/reception pilot signals may indicate a plurality of transmission pilot signals and/or a plurality of reception pilot signals.

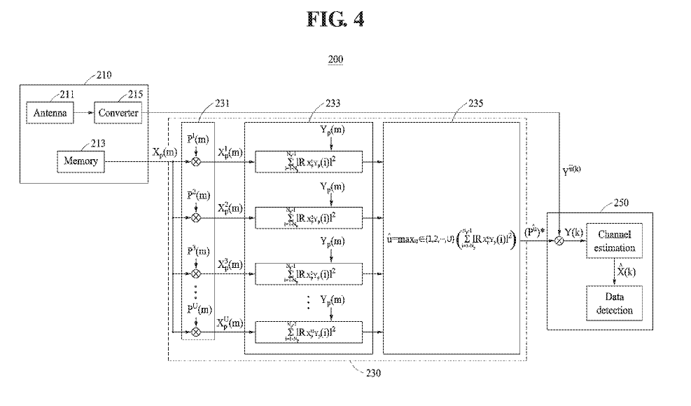

For example, the transmission pilot signal and the phase sequence are the frequency domain signal and/or the time domain signal. Detailed description about a structure and an operation of the receiver 210 is provided with reference to FIG. 4.

The calculator 230 may detect the phase sequence used for the transmission signal based on an output signal output from the receiver 210. For example, the output signal includes a transmission pilot signal, a phase sequence, and a reception pilot signal used in the transmitting apparatus 100. The calculator 230 may output the detected phase sequence (or detected phase sequence information) to the detector 250. For example, a signal received by the calculator 230 includes the transmission pilot signal, the phase sequence, or the reception pilot signal, and the transmission pilot signal, the phase sequence, or the reception pilot signal may be time domain signals and/or frequency domain signals.

The detector 250 may perform a channel estimation, a channel interpolation, and a data detection. For example, the detector 250 detects transmission data based on the detected phase sequence and the data signal. Here, the detector 250 may detect the transmission data by performing a maximum likelihood (ML) method as a data detecting method.

FIG. 3 is a block diagram illustrating the calculator 230 according to an example embodiment.

Referring to FIG. 3, the calculator 230 includes a multiplier 231, a cross-correlation operator 233, and a selector 235.

The multiplier 231 modulates a transmission pilot signal. For example, the multiplier 231 receives the transmission pilot signal and a plurality of phase sequences from the receiver 210. The multiplier 231 may generate the modulated transmission pilot signal, for example, a plurality of signals obtained by modulating a transmission pilot signal, by multiplying the transmission pilot signal by the phase sequences.

The multiplier 231 may output the modulated transmission pilot signal to the cross-correlation operator 233.

The cross-correlation operator 233 may generate cross-correlation values by performing a cross-correlation operation on the modulated pilot signal and the reception pilot signal received from the receiver 210. For example, a plurality of reception pilot signals are provided, and a number of reception pilot signals corresponds to a number of subcarriers.

The cross-correlation operator 233 may perform an operation of squaring and adding the generated cross-correlation values.

The cross-correlation operator 233 may output the cross-correlation values to the selector 235. Detailed description about an operation of generating the cross-correlation values by the cross-correlation operator 233 is provided with reference to FIG. 4.

The selector 235 may detect the phase sequence used for the transmission signal based on the cross-correlation values. Detailed description about an operation of detecting the phase sequence by the selector 235 is provided with reference to FIG. 4.

The selector 235 may output the detected phase sequence to the detector 250.

Hereinafter, detailed description about an operation of each configuration of the communication device 50 is provided with reference to FIGS. 4 through 6.

FIG. 4 illustrates an example of an operation of the communication apparatus of FIG. 2.

Referring to FIG. 4, the receiver 210 includes an antenna 211, a memory 213, and a converter 215.

The antenna 211 receives a signal, for example, a reception signal, transmitted from the transmitting apparatus 100. The antenna 211 outputs the reception signal to the converter 215. For example, the reception signal is a time domain signal obtained in response to the transmission signal transmitted from the transmitting apparatus 100 passing through a channel. In addition, the reception signal includes an additive white Gaussian noise (AWGN) and a response value of a fading channel.

The memory 213 stores a transmission pilot signal and a phase sequence used in the transmitting apparatus 100. The memory 213 outputs the transmission pilot signal and the phase sequence to the calculator 230.

The converter 215 obtains (or detects) a reception pilot signal and a data signal from the reception signal. In addition, the converter 215 may perform a fast Fourier transform (FFT). For example, the reception pilot signal and the data signal may be signals transformed to frequency domain signals.

The converter 215 may output the reception pilot signal and the data signal to the calculator 230.

The multiplier 231 may perform a multiplication using the transmission pilot signal and the phase sequence output from the memory 213. For example, the multiplier 231 generates the transmission pilot signal, for example, a plurality of signals obtained by modulating transmission pilot signals, modulated by multiplying each transmission pilot signal by a plurality of phase sequences. A number of the modulated transmission pilot signals may correspond to a number of phase sequences. An example of the modulated transmission pilot signal is expressed as shown in Equation 7.

Xₚ^{u}(m)=Xₚ(m)P^{u}(m) [Equation 7]

In Equation 7, m denotes an index for indicating a plurality of subcarriers, and u denotes an index for indicating a plurality of phase seqeunces. That is, a plurality of transmission pilot signals and a plurality of phase sequences may be provided. Xₚ(m) denotes a transmission pilot signal corresponding to an m-th subcarrier, and P^{u}(m) denotes a u-th phase seqeunce.

When it is assumed that the number of subcarriers corresponds to Nₚ, m has a range of 1≤m≤Nₚ, and Nₚ denotes the number of transmission pilot signals. When a number of phase sequences corresponds to U, u has a range of 1≤u≤U.

The multiplier 231 may output the modulated transmission pilot signals, for example, Xₚ^{u}(m), to the cross-correlation operator 233. Here, a number of the modulated transmission pilot signals, for example, Xₚ^{u}(m), may be up to N_{p×}U.

The cross-correlation operator 233 may receive the modulated transmission pilot signal Xₚ^{u}(m) output from the multiplier 231 and receive a reception pilot signal Yₚ(m) output from the converter 215.

The cross-correlation operator 233 may perform a cross-correlation operation based on the modulated transmission pilot signal Xₚ^{u}(m) and the reception pilot signal Yₚ(m). For example, the cross-correlation operator 233 generates a cross-correlation value R_{X}_{ₚ}_{^{u}}_{Y}_{ₚ}(i) by multiplying a conjugate complex number value of the modulated transmission pilot signals and the reception pilot signals based on each of the subcarriers in an OFDM symbol. The cross-correlation value R_{X}_{ₚ}_{^{u}}_{Y}_{ₚ}(i) is expressed as shown in Equation 8.

$${R}_{{X}_{p}^{u} {Y}_{p}} ( i ) = {\sum }_{m = 1}^{{N}_{P}} {{X}_{p}^{u} ( m + i )}^{*} {Y}_{p} ( m ) , 1 \leq m + i \leq {N}_{p} \qquad [ Equation 8 ]$$

In Equation 8, R_{X}_{ₚ}_{^{u}}_{Y}_{ₚ}(i) denotes a cross-correlation value, and Xₚ^{u}(m+i)* denotes a conjugate complex number value of the transmission pilot signal modulated by the u-th phase sequence of an m+i-th subcarrier. Also, Yₚ(m) denotes a reception pilot signal transmitted by an m-th subcarrier, and Nₚ denotes the number of transmission/reception pilot signals.

The cross-correlation operator 233 may generate the cross-correlation value of each phase sequence by performing an operation associated with Equation 8 for each phase sequence. That is, the cross-correlation operator 233 may generate the cross-correlation value by repeating the operation associated with Equation 8 U times.

The cross-correlation operator 233 may perform an operation of squaring and adding all cross-correlation values calculated from each subcarrier. The cross-correlation operator 233 may repeat the operation with respect to all phase sequences to be applied to one symbol.

The cross-correlation operator 233 may output values obtained by squaring and adding the generated cross-correlation values to the selector 235.

The selector 235 may select a phase sequence based on the values obtained by squaring and adding the cross-correlation values, and detect the selected phase sequence as a phase sequence used for the transmission signal.

The selector 250 may select a phase sequence obtained in response to a maximum sum of squares of the cross-correlation values, and detect the selected phase sequence as a phase sequence used for the transmission signal. The maximum sum of squares of cross-correlation values indicates a greatest similarity. An operation of detecting the phase sequence is expressed as shown in Equation 9.

$${u}^{⋒} = {max}_{u ∈ \{ 1 , 2 , … , U \}} ( {\sum }_{i = 1 - {N}_{p}}^{{N}_{p} - 1} \vert {R}_{{X}_{p}^{u} {Y}_{p}} ( i ) {\vert}^{2} ) \qquad [ Equation 9 ]$$

In Equation 9, û denotes an index of a selected phase sequence, R_{X}_{ₚ}_{^{u}}_{Y}_{ₚ}(i) denotes a cross-correlation value of a modulated transmission pilot signal Xₚ^{u} and a reception pilot signal Yₚ, and Nₚ denotes the number of transmission signals or a number of reception pilot signals in an OFDM symbol.

Subsequently, the selector 250 may output information on the detected phase sequence to the detector 250.

The detector 250 may perform a channel estimation, a channel interpolation, and a data detection.

The detector 250 may perform the channel estimation and the channel interpolation through a pilot signal. For example, a pilot signal includes a transmission pilot signal and/or a reception pilot signal. For example, a method of channel estimation is a least square (LS) method and a method of channel interpolation is a linear interpolation method.

The detector 250 may perform the data detection based on the reception pilot signal and the data signal transmitted from the converter 215 and a conjugate complex number value of the phase sequence detected from the selector 235.

The method of data detection may be a maximum likelihood (ML) method. A method of detecting data in the ML method is expressed as shown in Equation 10.

$$D = {min}_{u ∈ \{ 1 , 2 , … , U \}} {\sum }_{k = 0}^{N} {min}_{\hat{X} ( k ) ∈ Q} \vert {Y}_{d} ( k ) {{P}^{\tilde{u}} ( k )}^{*} - \hat{H} ( k ) {\hat{X}}_{d} ( k ) {\vert}^{2} \qquad [ Equation 10 ]$$

In Equation 10, D denotes a detection metric, and Y_{d}^{ũ}(k) denotes a data signal modulated by the phase sequence used for the transmission signal of a k-th subcarrier. Also, P^{û}(k)′ denotes a conjugate complex number value of the phase sequence detected from the k-th subcarrier, and Ĥ_{d}^{û}(k) denotes an estimated channel response of the k-th subcarrier. \hat{X}_{d}(k) denotes the detected data signal corresponding to the k-th subcarrier and Q denotes a symbol based on a modulation method.

Hereinafter, description about performance of the above-described examples is provided.

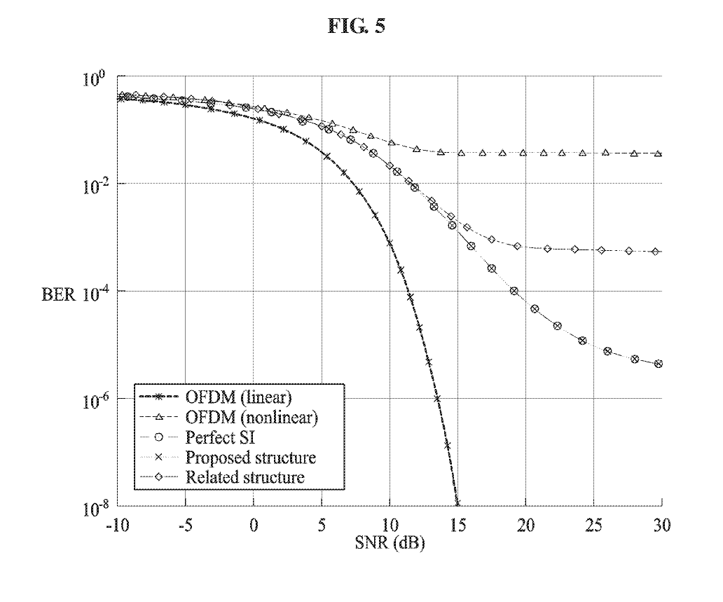

FIG. 5 is a graph illustrating an example of a phase sequence detecting performance of the communication apparatus 50 of FIG. 2.

FIG. 5 is a graph indicating a bit error rate (BER) performance of a signal-to-noise ratio (SNR) through simulation based on the phase sequence detecting method described with reference to FIG. 4.

FIG. 5 represents a BER of the present disclosure in comparison with a BER of the related technology in an orthogonal frequency division multiplexing (OFDM)-selected mapping (SLM) system including 1024 subcarriers and 128 pilot signals. Here, four phase sequences and an additive white Gaussian noise (AWGN) channel are used, and a nonlinear amplifier uses a solid state power amplifier (SSPA) Rapp model of which a parameter corresponds to 2.

As illustrated in FIG. 5, a BER performance of the communication method proposed in the present disclosure is greatly enhanced as an SNR value increases in comparison with a conventional method.

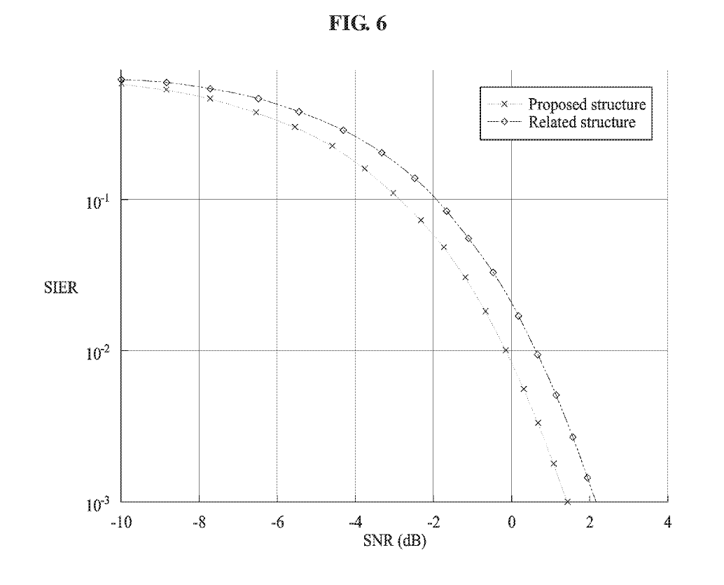

FIG. 6 is a graph illustrating another example of a phase sequence detecting performance of the communication apparatus 50 of FIG. 2.

FIG. 6 is a graph representing a side information error rate (SIER) performance of a signal-to-noise ratio (SNR) through simulation.

The SIER indicates a probability that the receiving apparatus 200 fails to detect side information (SI).

FIG. 6 represents an SIER of the present disclosure in comparison with an SIER of the related technology in an orthogonal frequency division multiplexing (OFDM)-selected mapping (SLM) system including 1024 subcarriers in the additive white Gaussian noise (AWGN) channel. The present disclosure has approximately 0.5 decibels (dB) of an SNR gain for detecting side information (SI) in comparison with the related technology.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The units and/or modules described herein may be implemented using hardware components and software components. For example, the hardware components may include microphones, amplifiers, band pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claim.

What is claimed is:

1. A communication method comprising:
obtaining a reception pilot signal from a reception signal; and
detecting a phase sequence used for a transmission pilot signal based on the reception pilot signal in the OFDM-SLM (Orthogonal Frequency Division Multiplexing-SeLected Mapping) symbol.

2. The communication method of claim 1, wherein the detecting comprises:
detecting the used phase sequence at a transmitter by performing a cross-correlation based on the reception pilot signal and a transmission pilot signal.

3. The communication method of claim 2, wherein the detecting of the used phase sequence by performing the cross-correlation comprises:
modulating the transmission pilot signal by multiplying the transmission pilot signal by a plurality of phase sequences;
generating cross-correlation values by performing a cross-correlation operation on the modulated transmission pilot signal and the reception pilot signal, and squaring and adding the cross-correlation values; and
detecting the used phase sequence by selecting a maximum value from values obtained by squaring and adding the cross-correlation values.

4. The communication method of claim 3, wherein the detecting comprises detecting the used phase sequence based on the following equation:
$${u}^{⋒} = {max}_{u ∈ \{ 1 , 2 , … , U \}} ( {\sum }_{i = 1 - {N}_{p}}^{{N}_{p} - 1} \vert {R}_{{X}_{p}^{u} {Y}_{p}} ( i ) {\vert}^{2} )$$
wherein û denotes an index of a phase sequence to be detected, R_{X}_{ₚ}_{^{u}}_{Y}_{ₚ}(f) denotes a cross-correlation value of a modulated transmission pilot signal Xₚ^{u} and a reception pilot signal Yₚ, and Nₚ denotes a number of transmission pilot signals or a number of reception signals in an OFDM symbol.

5. The communication method of claim 4, wherein the generating comprises determining the cross-correlation values based the following equation:
$${R}_{{X}_{p}^{u} {Y}_{p}} ( i ) = {\sum }_{m = 1}^{{N}_{P}} {{X}_{p}^{u} ( m + i )}^{*} {Y}_{p} ( m ) , 1 \leq m + i \leq {N}_{p}$$
wherein Xₚ^{u} denotes the modulated transmission pilot signal, Yₚ denotes the reception pilot signal, and Nₚ denotes the number of the transmission pilot signals or the number of the reception signals in the OFDM symbol.

6. The communication method of claim 1, further comprising:
detecting data based on the detected phase sequence.

7. The communication method of claim 6, wherein the detecting of the data comprises detecting the data based on a maximum likelihood (ML) method using the detected phase sequence.

8. A communication apparatus comprising:
a receiver configured to obtain a reception pilot signal from a reception signal; and
a calculator configured to detect a phase sequence used for a transmission pilot signal based on the reception pilot signal in the OFDM-SLM (Orthogonal Frequency Division Multiplexing-SeLected Mapping) symbol.

9. The communication apparatus of claim 8, wherein the calculator is configured to detect the used phase sequence at a transmitter by performing a cross-correlation based on the reception pilot signal and a transmission pilot signal.

10. The communication apparatus of claim 9, wherein the calculator includes:
a multiplier configured to modulate the transmission pilot signal by multiplying the transmission pilot signal by a plurality of phase sequences;
a cross-correlation operator configured to generate cross-correlation values by performing a cross-correlation operation on the modulated transmission pilot signal and the reception pilot signal, and squaring and adding the cross-correlation values; and
a selector configured to detect the used phase sequence by selecting a maximum value from values obtained by squaring and adding the cross-correlation values.

11. The communication apparatus of claim 10, wherein the selector is configured to detect the used phase sequence based on the following equation:
$${u}^{⋒} = {max}_{u ∈ \{ 1 , 2 , … , U \}} ( {\sum }_{i = 1 - {N}_{p}}^{{N}_{p} - 1} \vert {R}_{{X}_{p}^{u} {Y}_{p}} ( i ) {\vert}^{2} )$$
wherein û denotes an index of a phase sequence to be detected, R_{X}_{ₚ}_{^{u}}_{Y}_{ₚ}(i) denotes a cross-correlation value of a modulated transmission pilot signal Xₚ^{u} and a reception pilot signal Yₚ, and Nₚ denotes a number of transmission pilot signals or a number of reception pilot signals in an OFDM symbol.

12. The communication apparatus of claim 11, wherein the cross-correlation operator is configured to determine the cross-correlation values based on the following equation:
$${R}_{{X}_{p}^{u} {Y}_{p}} ( i ) = {\sum }_{m = 1}^{{N}_{P}} {{X}_{p}^{u} ( m + i )}^{*} {Y}_{p} ( m ) , 1 \leq m + i \leq {N}_{p}$$
wherein Xₚ^{u} denotes the modulated transmission pilot signal, Yₚ denotes the reception pilot signal, and Nₚ denotes the number of the transmission pilot signals or the number of the reception pilot signals in the OFDM symbol.

13. The communication apparatus of claim 8, further comprising:
a detector configured to detect data based on the detected phase sequence.

14. The communication apparatus of claim 13, wherein the detector is configured to detect the data based on a maximum likelihood (ML) method using the detected phase sequence.
